(19) United States
(12) Patent Application Publication
(10) Pub. No.: US 2025/0121729 A1
(43) Pub. Date: Apr. 17, 2025

(54) ELECTRIC VEHICLE CHARGING SYSTEM, CHARGING DEVICE, ELECTRIC POWER LENDING/BORROWING SYSTEM, ELECTRIC RATE LIQUIDATION SYSTEM, AND ELECTRIC VEHICLE

(71) Applicant: Masahide Tanaka, Osaka (JP)

(72) Inventor: Masahide Tanaka, Osaka (JP)

(73) Assignee: NL Giken Incorporated, Osaka (JP)

(21) Appl. No.: 18/916,535

(22) Filed: Oct. 15, 2024

(30) Foreign Application Priority Data
Oct. 15, 2023 (JP) 2023-177939

(51) Int. Cl. B60L 53/66; B60L 53/62; B60L 53/65; G06Q 30/04; G06Q 50/06

(52) U.S. Cl. CPC B60L 53/665; B60L 53/62; B60L 53/65; G06Q 30/04; G06Q 50/06

(57) ABSTRACT

A household has a parking space with charging apparatus for an electric vehicle connected to a home use commercial power source. The parking space allows another person's electric vehicle to charge it. Identification of such electric vehicle on its license plate or the like and amount of charging it are reported to an electric power lending/borrowing system which controls electric rate liquidation so that the household is billed for the total electric power minus the power charging the electric vehicle, and that the power charging the electric vehicle is billed to an owner of the electric vehicle. The electric power lending/borrowing system discloses the location of reachable households in the system on the map of car navigation system of electric vehicles also in the system.

### BACKGROUND OF THE INVENTION

### 1. Field of the Invention

The present invention relates to an electric vehicle charging system, charging device, and electric vehicle (EV).

### 2. Description of the Related Art

The development of charging infrastructure is essential for the widespread use of electric vehicles such as electric cars. Specifically, it is necessary to deploy charging stations on the road network so that there are no obstacles to driving. As part of this effort, efforts are being made to deploy charging stations at facilities where electric vehicles stop, such as car dealerships, convenience stores, and parking lots. Requests are also being considered to install charging systems in the garage of home. In order to promote the installation of charging stations and charging systems, cost-sharing is being considered by Japanese Publication No. 2019-121148, for example,

On the other hand, when charging electric vehicles in parking lots and charging spaces of apartment complexes, studies are being conducted to keep electricity rates as low as possible while flexibly responding to users' urgent charging needs such as in Japanese Publication No. 2013-258823.

However, there are still issues that need to be further explored to promote the installation of charging stations and charging systems, as well as to rationalize electricity rates.

### SUMMARY OF THE INVENTION

In view of the above, the problem to be solved by the present invention is to improve the manner of electric rete payment for promoting the installation of charging stations and charging systems and to provide an improved electric vehicle charging system, a charging device, electric power lending/borrowing system, electric rate liquidation system, and an electric vehicle.

According to a feature of the present invention, an electric vehicle charging system is proposed, which comprises a building having a power consumption unit, a parking space attached to the building, a charging apparatus for charging electric vehicles in the parking space, an electric power supply unit supplying power to the building and the charging device, and an electric power lending/borrowing system, wherein when any electric vehicle is parked in the parking space and charged by the charging device due to the power supply unit, the electric power lending/borrowing system controls electric rate liquidation so that the electric power supply unit is billed for the electric power supply unit minus the electric power charging the electric vehicle, and that the electric power charging the electric vehicle is billed to an owner of the electric vehicle.

According to another feature of the present invention, a charging apparatus connected to a commercial power source for supplying power to any electric vehicle in a parking space where any electric vehicle can be parked is proposed, which comprises an information acquiring unit for acquiring information for identifying the electric vehicle, a measuring unit for measuring amount of power for charging the electric vehicle, and a communication unit for informing a power lending/borrowing system of the information for identifying the electric vehicle and amount of power for charging the electric vehicle for the purpose of such an electric rate liquidation that the electric power supply unit is billed for the electric power supply unit minus the electric power charging the electric vehicle, and that the electric power charging the electric vehicle is billed to an owner of the electric vehicle, wherein the power lending/borrowing system reporting necessary information to the commercial power source for billing liquidated electric rate.

According to still another feature of the present invention, a power lending/borrowing system is proposed, which comprises a charging management system that enables to charge any electric vehicle by a charging device installed in a parking space attached to a private residence and to liquidates electric rate between the private residence and the owner of the electric vehicle, and a communication unit for informing electric vehicles on their navigation systems, respectively, of the location of the private residences reachable by the electric vehicles, respectively.

### BRIEF DESCRIPTION OF THE DRAWINGS

FIG. 1 represents a block diagram of an overall electric power lending/borrowing system related to an embodiment of the present invention.

FIG. 2 represents a block diagram showing details of the electric power company, the charge management company, and the first household in FIG. 1, together with other relating parts.

FIG. 3 represents a flowchart showing the operation of the charging controller of the charging unit is FIG. 2.

FIG. 4 represents a flowchart showing the details of the charge control process in step S14 of FIG. 3.

FIG. 5 represents a flowchart showing the details of the available time zone setting process in step S2 of FIG. 3.

FIG. 6 represents a flowchart showing the details of the emergency power receiving process in step S18 of FIG. 3.

FIG. 7 represents a flowchart showing the operation of the navigation control function of the EV controller in the first vehicle shown in FIG. 2.

FIG. 8 represents a flowchart showing the operation of the management controller of charging management company in FIG. 1.

### DETAILED DESCRIPTION OF THE PREFERRED EMBODIMENTS

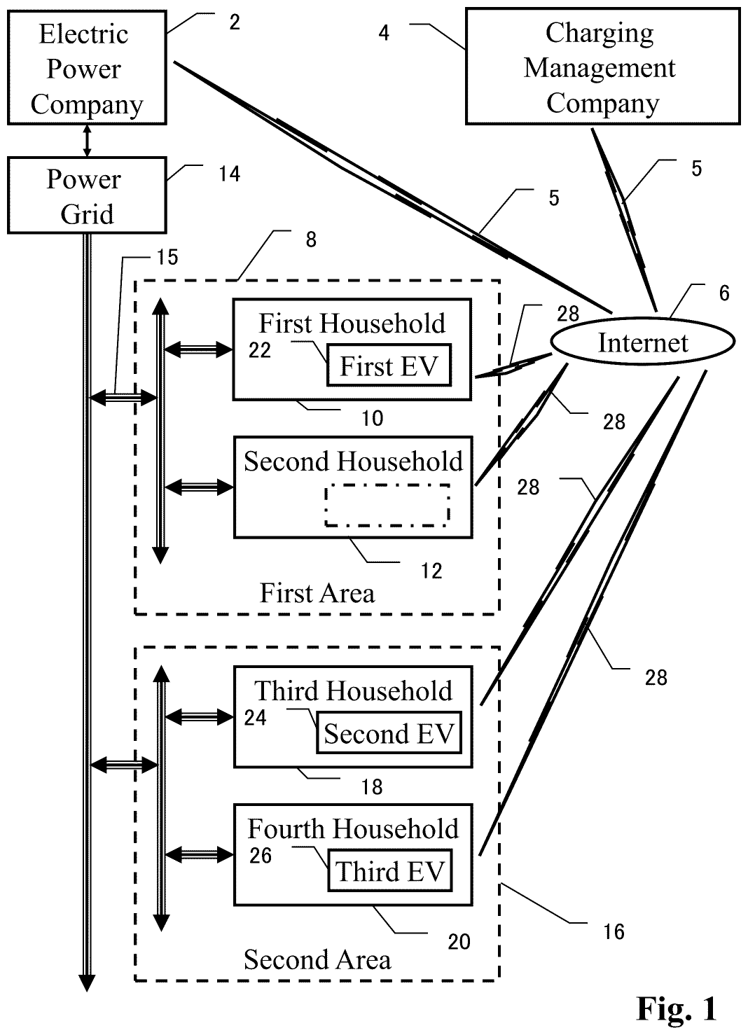

FIG. 1 shows a block diagram of an overall electric power lending/borrowing system related to an embodiment of the present invention. The system includes electric power supply system (hereinafter referred to as “electric power company” as a representative) 2 that serves as a commercial power source, charging management system (hereinafter referred to as “charging management company” as a representative) 4 that coordinates with electric power company 2 and controls electric power lending/borrowing and electric rate liquidation, and Internet 6 that connects them via communication network 5. First area 8 is a local area that includes first household 10 and second household 12, etc., and is grouped together by branch 15 of the power grid 14 controlled by electric power company 2. Similarly, second area 16 is a local area that includes third household 18 and second household 20, etc. The charging system includes many other areas, but for simplicity, first area 8 and second area 16 are shown in FIG. 1 Although first area 8 includes many other households, for simplicity, first household 10 and second household 12 are shown in FIG. 1. Second area 16 including many other households is likewise shown with only third household 18 and fourth household 20, for simplicity.

First household 10, second household 12, third household 18, and fourth household 20 are fed by branch 15 of the power grid 14 for their respective areas. First electric vehicle (e.g., electric car, etc.) 22 owned by first household 10 is parked in its own parking space in first household 10. The parking space in second household 12 in first area 8 is currently vacant because second electric vehicle 24 owned by second household 12 has left there for traveling. While traveling, second electric vehicle 24 is now parked in the parking space of third household 18 in second area 16 for charging power. However, people in second household 12 and people in third household 18 are not acquainted with each other. Fourth household 20 does not currently own any vehicle, but it does have a parking space available for charging a vehicle(s). Thus, while short trip within second area 16, third electric vehicle 26 owned by third household 18 is now parked in the parking space of fourth household 20 in second area 16 for charging power. However, people in third household 18 and people in fourth household 20 are not acquainted with each other.

First households 10, second household 12, third household 18, and fourth household 20 are subscribers to an electric power lending/borrowing system managed by electric power company 2 and charging management company 4, respectively, and their electric vehicles can freely park and charge in empty parking spaces of other households subscribing to the electric power lending/borrowing system as described above. In other words, an electric vehicle owned by a household that is a member of the electric power lending/borrowing system can be freely parked and charged in the empty parking spaces of other households that are members of the electric power lending/borrowing system. Each household does not share any information with the other households except the fact that they are subscribing to the electric power lending/borrowing system, respectively, thus their privacy is protected from the others. In addition, liquidation of electric rate for the charging electric power borrowed from other households is managed by electric power company 2 and charge management company 4 that are linked. For this purpose, each household is connected to electric power company 2 and charge management company 4 via the Internet 6 through communication network 28. Details of the electric power lending/borrowing and electric rate liquidation will be described below.

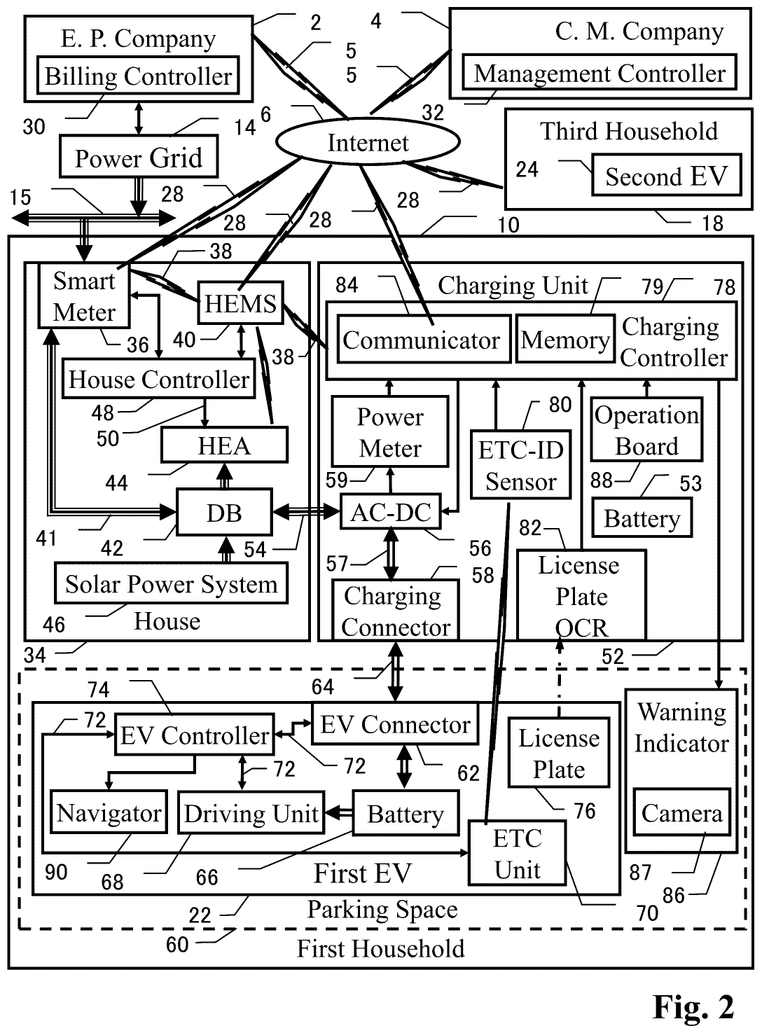

FIG. 2 is a block diagram showing details of electric power company 2, charge management company 4, and first household 10 in FIG. 1, together with communication network 5, Internet 6, power grid 14, branch 15, third household 18, and second electric vehicle 24 for the purpose of illustrating the entire system. For simplicity, first area 8, to which first household 10 belongs, and second area 16, to which third household 18 belongs, are omitted from FIG. 2. As is apparent in FIG. 2, electric power company 2 has billing controller 30 that controls the billing of electric rate for the supplied electric power. The functions of billing controller 30 will be described later. Charging management company 4 has management controller 32 that controls the electric power lending/borrowing and electric rate liquidation. The functions of management controller 32 will also be described below.

In FIG. 2, house 34 of first household 10 is supplied with power from branch 15 of power grid 14 via smart meter 36. Smart meter 36 is connected to electric power company 2 and charge management company 4 by Internet 6 through communication network 28, and reports the electric power used by first household 10 corresponding to meter reading results to electric power company 2 through Internet communication. The power used by first household 10 includes the charging power for an electric vehicle parked in parking space 60. This means that the power used by first household 10 includes the charging power not only for first electric vehicle 22, but also for other electric vehicle(s) of other household(s) if such electric vehicle(s) is parked in parking space 60 of first household 10. In other words, if second electric vehicle 24 of second household 12, for example, is parked and charged in place of first electric vehicle 22, the power used by first household 10 includes the charging power “borrowed” by second household 12. Smart meter 36 is linked to home energy management system 40 (hereinafter referred to as “HEMS 40”) via short-range wireless communications 38. The linkage between the two may be by wired or power line communications in place of short-range wireless communications 38. Although not shown in FIG. 2, HEMS 40 is also linked to the distribution board (DB) 42 by short-range wireless communication or wired communication or power line communication. HEMS 40 is also connected to electric power company 2 and charge management company 4 by Internet 6 through communication network 28.

Distribution board 42 is connected to smart meter 36 by leading-in cable 41, and distributes electric power supplied from electric power company 2 to home electric appliances (HEA) 44 including lighting, air conditioning, and television set etc. through in-home wiring. House 34 is also equipped with a private power generation system (hereinafter described as solar power system 46 as a representative, but wind power generation systems, etc. are also applicable), which is connected to distribution board 42 by in-home wiring. The solar power system 46 has an energy storage unit and a DC-AC converter, and supplies AC output to the distribution board 42 via the in-home wiring to supply solar-generated power to the electrical equipment in first household 10, and also sells surplus power to electric power company 2 via the smart meter 36. The solar-generated power from solar power system 46 is also used to charge electric vehicles. In addition, the solar power system 46 is connected to HEMS 40 via short-range wireless communication 38 or wired or power line communication for its management.

House 34 is further equipped with an house controller 48, which is connected by LAN cable 50 to home electric appliances 44, smart meter 36, HEMS 40, and other necessary parts of house 34, and through communication with these parts, the entire house 34 is under overall control. The connection from the house controller 48 to the home electric appliances 44, smart meter 36, HEMS 40, etc. can be alternatively made by short-range wireless communication 38 or power line communication. House controller 48 also works with the HEMS 40 to control distribution board 42 so that when charging another person's electric vehicle while solar power is being generated by solar power system 46, the power supplied by solar power system 46 is given priority over the power supplied by electric power company 2 to charge the another person's electric vehicle. As described below, this control results in the power supplied by the solar power system 46 being sold to electric power company 2.

Charging unit 52 is a unit that charges electric vehicles and manages the charging of electric vehicles, and has an AC-DC converter 56 connected to distribution board 42 with in-home wiring 54. AC-DC converter 56 converts AC power from distribution board 42 to DC power and is connected with charging connector 58 through DC cable 57. On the other hand, AC-DC converter 56 can, if necessary, receive DC power flowing back from the charging connector 58 due to discharge of a storage battery of an electric vehicle, convert it to AC power, and supply it to the distribution board 42. This allows first household 10 to obtain necessary power from the electric vehicle even in the event of a power outage, etc. This exchange of power through AC-DC converter 56 is measured by power meter 59. AC-DC converter 56 has a switch function and a breaker function inside it, and can be disconnected from the distribution board 42 as necessary under the control of the charging controller 78 described below. Charging unit 52 is equipped with storage battery 53, which stores surplus power in first household 10 and supplies power to first household 10 any time if necessary. Storage battery 53 also ensures the continued operation of the charging unit 52 in the event of a power outage due to a disaster, etc., as described below.

In FIG. 1, it has been illustrated that another person's second electric vehicle 24 is parked for charging in third household 18. Similarly in the case of FIG. 2, the present invention allows, not only first vehicle 22, but also an electric vehicle owned by another person to be connected to charging connector 58 of first household 10 for charging. In principle, such electric vehicles of others are charged from the charging connector 58 unidirectionally, and bidirectional energy flow through charging connector 58 is not considered. In other words, first household 10 does not receive power supply from the electric vehicles of others via the charging connector 58 in normal case. As an exception, however, only in the event of a disaster or other emergency, it is possible for charging connector 58 to receive power supply from other people's electric vehicles. In such cases, other people who cooperate in providing power to first household 10 by means of its electric vehicle can receive official compensation for the power based on an official application through charging management company 4. The details of this are described below. In the case that the power line communication is used in house 34, AC-DC converter 56 has a function to block the communication signals so that others cannot penetrate the private information in first household 10 through charging connector 58 when vehicle of another person is connected to charging connector 58.

According to the illustration in FIG. 2 as it is. first electric vehicle 22 with EV connector 62 is parked in parking space 60 of first household 10. By connecting EV connector 62 and charging connector 58 with charging cable 64, it is possible for electric vehicle 22 to charge storage battery 66. Driving unit 68, such as a motor, is possible to drive first electric vehicle 22 with the power from storage battery 66. In addition, first electric vehicle 22 is equipped with ETC unit 70 according to the electronic toll collection system (hereinafter referred to as “ETC”), in which first vehicle 22 is capable of wireless communication with its antenna at toll stations, etc. First electric vehicle 22 is further equipped with EV controller 74 to control driving unit 68, EV connector 62, ETC unit 70, etc., which are connected by wiring 72 in the vehicle to control the entire first electric vehicle 22. First electric vehicle 22 also has a conventional license plate 76.

Charging unit 52 is provided with charging controller 78, which receives information on the meter reading results of power meter 59. Charging unit 52 is further provided with ETC-ID sensor 80, which recognizes the ETC-ID for identifying first electric vehicle 22 according to ETC through wireless communication with ETC unit 70 of the first electric vehicle 22 parked in parking space 60 and reports it to charging controller 78. In addition, license plate optical character reader (OCR) 82 connected to charging controller 78 optically reads information on the license plate 76 identifying first electric vehicle 22 by imaging license plate 76 of the first electric vehicle 22 parked in parking space 60, and reports it to charging controller 78. Thus, ETC-ID sensor 80 and license plate OCR 82 both have the function of identifying the electric vehicle parked in parking space 60 of the A household 10. Therefore, although only one of the ETC-ID sensor 80 or license plate OCR 82 is sufficient to identify the electric vehicle, both are used together for cross-checking in the embodiment. The above is meaningful under the situation that, not only own electric vehicle, but also another person's electric vehicle it to charge through charging connector 58.

If, as described above, one or both of ETC-ID sensor 80 and license plate OCR 82 can identify that it is first electric vehicle 22 parked in the parking space 60, the charging controller 78 permits charging from the charging connector 58. In this case, smart meter 36 reports the power consumption by first electric vehicle 22 in addition to the power consumption by house 34 to electric power company 2 via Internet 6, and electric power company 2 bills the reported power rate to first household 10. If solar power system 46 can completely cover the charging of the electric vehicle 22, there is no power consumption via the smart meter 36, so there is no charge for charging first electric vehicle 22. In case of own electric vehicle, home electric appliances 44 can be powered by the discharge of the storage battery 66 through charging connector in case of necessity. In other words, where first electric vehicle 22 is concerned, energy flow through charging connector 58 is bidirectional. In this case, if some power consumption by home electric appliances 44 in house 34 is covered by the discharge of the storage battery 66, there is no power consumption via the smart meter 36, so there is no billing for that portion.

Next, explanation will be made about the case where one or both of ETC-ID sensor 80 and license plate OCR 82 identify that the electric vehicle parked in parking space 60 is an electric vehicle that is owned by someone else. This corresponds, for example, to the case where the second electric vehicle 24 is parked in the third household 18 and is being charged in FIG. 2. Although omitted in FIG. 2, it is assumed that third household 18 has just the same configuration as in first household 10 and second electric vehicle 24 has just the same configuration as in first electric vehicle 22.

To avoid confusion, the explanation will be made with respect to first household 10 wherein second electric vehicle 24, in place of first electric vehicle 22, is parked in parking space 60 and receives electric power. (In the following description, accordingly, the configuration of first electric vehicle 22 in FIG. 2 will be read as those in second electric vehicle 24.) In this case, one or both of ETC-ID sensor 80 and license plate OCR 82 identify the second electric vehicle 24 parked in the parking space 60, and communication unit 84 of charging controller 78 reports this fact to the charging management company 4 via the Internet 6. Upon receiving the report, charging management company 4 checks whether or not second electric vehicle 24 is a member of the electric power lending/borrowing system, and if the membership is confirmed, it reports this fact to communication unit 84 of charging controller 78 via Internet 6. Charging controller 78 permits charging of second electric vehicle 24 from the charging connector 58 based on this report.

Power meter 59 measures the power supply from distribution board 42 to charging connector 58 via AC-DC converter 56, and reports this to the charging controller 78. Communicator 84 of the charging controller 78 reports the measured power supply to second electric vehicle 24 to charging management company 4 via Internet 6. Upon receiving the report, charging management company 4 reports the amount of electricity supplied to second electric vehicle 24 to electric power company 2 via Internet 6.

In the above, the power consumption of first household 10 reported to power company 4 from smart meter 36 includes not only the power consumption of first household 10 itself but also the power consumption for charging second electric vehicle 24. However, since the amount of electricity supplied to second electric vehicle 24 is reported to electric power company 2 by charge management company 4 as described above, power company 2 charges first household 10 the electricity rate obtained by subtracting the amount of electricity supplied to second electric vehicle 24 from the electricity consumption reported by first household 10 from smart meter 36. On the other hand, power company 2 bills second household 12 (see FIG. 1), which owns second electric vehicle 24, for the power consumption by second household 12 itself plus the power consumption for charging second electric vehicle 24 mentioned above. This means that even if second electric vehicle 24 is charged at first household 10, second household 12 will receive the same billing from power company 2 as if second vehicle 24 were charged at second household 12. This means that first household 10 will effectively not receive any billing for charging another person's electric vehicle. Thus, an electric vehicle subscribing to the electric power lending/borrowing system can be charged in one of convenient parking spaces of other households also subscribing to the electric power lending/borrowing system, even when the electric vehicle is far out of own household.

While charging second electric vehicle 24, if the total power consumption of first household 10 determined by the smart meter 36 (which is the power supplied from electric power company 2) is less than the sum of power consumption in house 34 determined by HEMS 40 and the power supplied to second electric vehicle 24 determined by the power meter 59, then the difference in power is internally supplied by solar power system 46. Even in this case, electric power company 2 will bill first household 10 for the power consumption of first household 10 reported by smart meter 36 minus the power supplied to second electric vehicle 24 and will bill second household 12 which owns second electric vehicle 24 for the power consumption by second household 12 itself plus the power consumption for charging second electric Vehicle 24 above. This means that the electricity provided by solar power system 46 out of the total amount of electricity supplied to the second electric vehicle 24 was sold by the first household 10 to electric power company 2.

According to the electric power lending/borrowing system of the present invention, even in a case that a system subscriber is a stranger to a household, the system subscriber can charge its electric vehicle in the private parking space of the household. Thus, for a security reason, the identification information (such as the license plate information recognizable by one or both of ETC-ID sensor 80 and license plate OCR 82) of second electric vehicle 24 in parking space 60 and the charging date and time are recorded in memory 79 of the charging controller 78, which can be viewed and inspected later at first household 10. According to the electric power lending/borrowing system of the present invention, the owner of the electric vehicle is to charge its electric vehicle in the parking space of another household, knowing and accepting in advance of such recording when the owner has newly become a system subscriber.

Parking space 60 of first household 10 is provided with warning indicator 86 controlled by charging controller 78 in a location easily visible both from the street and from the inside of parking space 60 for the following purposes. The first purpose is for such a case that own electric vehicle 22 has a plan to return in a short time even the parking space 60 is vacant at present. In other words, it is not desirable for parking space 60 to be occupied by someone else's electric vehicle coming to charge in spite of the returning plan of own electric vehicle 22. For avoiding the case above, time zone(s) during which charging by others is available is to be set in charging controller 78 in which such time zone(s) can be manually input at operation board 88 and stored in the memory 79. Under the control by charging controller 78, warning indicator 86 displays an indication of “charging OK” if parking space 60 is available during the set time zone(s), whereas warning indicator 86 displays “No Parking” during other than the set time zone(s).

The above explained available time zone of first household 10 set by charging controller 78 is transmitted by communication unit 84 to charge management company 4 via Internet 6. Charge management company 4 gathers such information of available time zone transmitted from each household and discloses the households with the “chargeable” setting on the map display of car navigation system 90 installed in the electric vehicle. The indication of households available for charging limitedly appears on the map of car navigation system 90 of the electric vehicles that are subscribers of the electric power lending/borrowing system. This allows electric vehicles on the road that subscribe to the electric power lending/borrowing system to know the nearest households that are available for charging when necessary.

If it is discovered that another person's electric vehicle is parked in parking space 60 despite the “No Parking” sign being displayed by warning indicator 86, warning indicator 86 also makes an audible announcement asking the driver of such a vehicle to leave parking space 60. Further, if another person's electric vehicle is parked in parking space 60 despite the “No Parking” sign, charging unit 52 informs charging management company 4 of the fact, and charging management company 4 notifies the police of the illegal parking on behalf of first household 10.

The second purpose of warning indicator 86 is to prevent an attempt of electricity theft or parking under the guise of charging by electric vehicles that are not subscribed to the electric power lending/borrowing system. The following explanation is to be made supposing that second electric vehicle 24 were not a member of the electric power lending/borrowing system. When charging management company 4 determines that an electric vehicle parked in parking space 60 is not a member of the electric power lending/borrowing system based on information from charging controller 78 due to ETC-ID sensor 80 or license plate OCR 82, it notifies the charging controller 78 of the determination. Upon receiving this determination from charging management company 4, charging controller 78 prohibits charging of second electric vehicle 24 from the charging connector 58, and a message such as “Illegal parking!” is displayed on the warning indicator 86 after a predetermined period of time. In addition, warning indicator 86 makes an audible announcement asking the driver of the vehicle to leave. On the other hand, when charging management company 4 determines that a vehicle in parking space 60 is not a member of the electric power lending/borrowing system, it also notifies the police on behalf of first household 10 after a predetermined period of time in parallel with the above described communication with first household 10.

The third purpose of warning indicator 86 is to prevent electric vehicles that are owned by others from remaining in parking space 60 for a longer period of time than necessary. Even if the determination of charging management company 4 is that the electric vehicle parked in parking space 60 is of a subscriber to the electric power lending/borrowing system, the parking may be a free use of another household's parking space as a mere substitute for a conventional parking concession. This will be also caused by such a case that the vehicle does not start charging immediately after parking or it does not immediately leave after charging has been completed, etc. For this reason, if an electric vehicle owned by another person stays in parking space 60 for a predetermined period of time or longer before or after charging starts, a message such as “Unauthorized Parking” will be displayed and a warning announcement will be made audibly to ask that charging should start immediately or that the electric vehicle should leave the parking space 60 immediately after charging is completed. If the electric vehicle does not start charging or not leave the parking space 60 within a predetermined time after this warning announcement, charging controller 78 reports this to charging management company 4, which in turn reports this to the police on behalf of first household. In connection with the above purposes, warning indicator 86 is provided with camera 87 covering parking space 60 to detect the presence or absence of electric vehicles and, if necessary, to take images of the electric vehicles for recording purposes.

The various features of the present invention are not limited to the above embodiment, but are widely applicable to other embodiment. For example, in the above embodiment, electric power company 2 performs the electric power lending/borrowing, but instead of this, charge management company 4 may perform the electric rate liquidation among households subscribing to the electric power lending/borrowing system by transferring money between registered bank accounts of households.

Further, the present invention is applicable, not only to the lending/borrowing of electric power between households, but also to electric rate liquidation of electric vehicle charging in parking lots of consumer-use business facilities (restaurants, supermarkets, etc.). This allows the facilities to expand their customer base while cooperating in the development of electric vehicle charging infrastructure, in which the facilities can rely on charge management company 4 for the electric rate liquidation of electric vehicle charging in their parking lots and for the electric rate liquidation upon selling electric power generated by the solar power system of the facilities to electric power company 2.

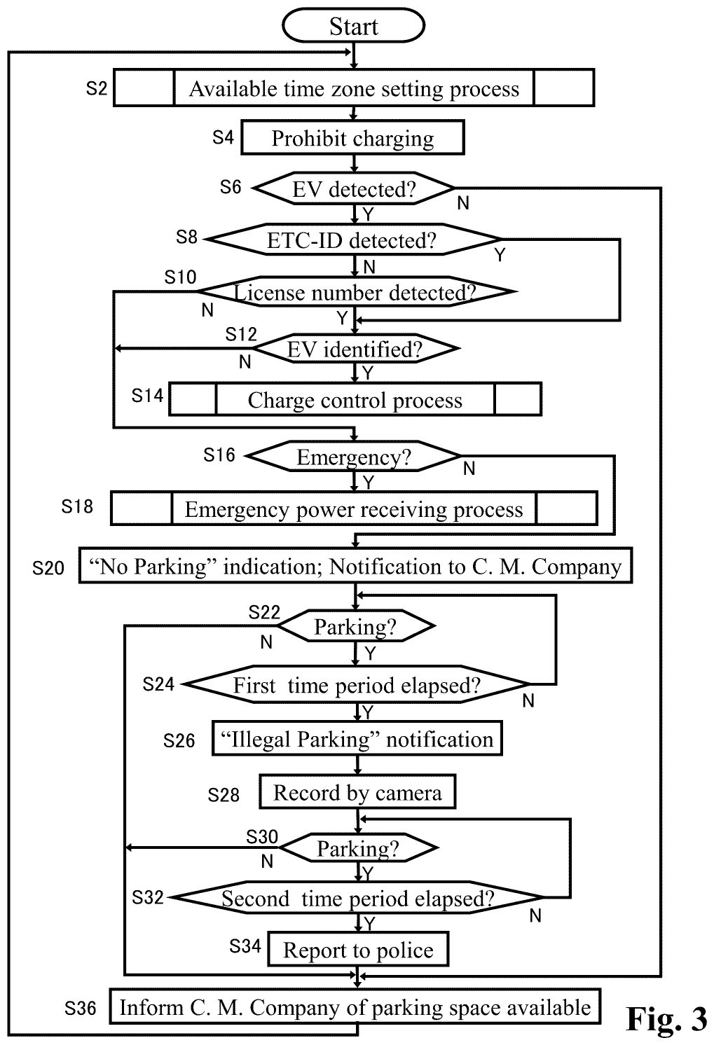

FIG. 3 is a flowchart showing the operation of the charging controller 78 of the charging unit 52 is FIG. 2. When the operation starts, the available time zone setting process to enable charging of other people's electric vehicles is performed in step S2. This process is necessary to enable charging of others' electric vehicles without interfering with charging of one's own electric vehicle, the details of which are described below. Then, the flow is advanced to step S4 to prohibit charging from charging connector 58.

The flow further proceeds to step S6 to detect whether or not any electric vehicle parking is present in parking space 60. If any parking is detected in step S6, the flow moves to step S8 to check whether the ETC-ID is detected by ETC-ID sensor 80. With no detection, the flow moves to step S10 to check whether license plate 76 is detected by license plate OCR 82, and if detection is made, the flow moves to step S12. If ETC-ID detection is made in step S8, the system also moves to step S12.

In step S12, the flow checks whether or not the vehicle has been identified based on the ETC-ID detection result or the license plate detection result. In this case, the vehicle identification means distinction between own electric vehicle and an electric vehicle of another person who is a member of the electric power lending/borrowing system. If the vehicle can be identified, the process moves to the charge control process in step S14, the details of which will be described below. On the other hand, if the vehicle identification is not possible in step S12, the process moves to step S16 to check whether it is an emergency situation or not. This is for such a case that normal management of power charge control process is not possible. If it is determined that the license plate cannot be detected in step S10, the system also moves to step S16 for the same reason. If it is determined in step S16 that the situation is an emergency, the flow moves to emergency power receiving process in step S18. This process is intended to enable first household 10 to receive power from any electric vehicle parked in parking space 60, even if the electric vehicle is not a member of the electric power lending/borrowing system, in the event of a disaster or other emergency, the details of which will be described below.

On the other hand. if it is not confirmed in step S16 that the situation is an emergency, the flow moves to step S20 to notifies charging management company 4 that an electric vehicle is parking and to ask whether or not the electric vehicle is outside the electric power lending/borrowing system, and to starts displaying “No Parking” at warning indicator 86 in response to the answer from charging management company 4. If the “No Parking” has already been displayed due to unavailable time zone, it is continued. The system then moves to step S22 to check whether or not parking continues. If parking is still detected in step S22, the flow moves to step S24 to check whether or not a first predetermined time period has elapsed. The first predetermined time period is set, for example, to 5 minutes after parking is detected in step S6. If the elapse of the first predetermined time period is not detected in step S24, the flow returns to step S22, and repeats steps S22 and S24 until the elapse of the first predetermined time period is detected in step S24. On the other hand, when the elapse of the first predetermined time period is detected in step S24, the flow moves to step S26 to announce illegal parking along with the indication change to “Illegal Parking!” and goes to step S28 to record the image of the parked vehicle by the camera 87 and moves to step S30.

In step S30, it is checked whether or not parking is ongoing. If it is determined that the another person's electric vehicle still parks after the elapse of the first predetermined time period. And, if such a continuation of parking is detected, the flow moves to step S32, wherein it is checked whether or not a second predetermined time has elapsed. The second predetermined time is set, for example, to 30 minutes after parking is detected in step S6. If the elapse of the second predetermined time period is not detected in step S32, the flow returns to step S30 and repeats steps S30 and S32 until the elapse of the second predetermined time period is detected. On the other hand, when the elapse of the second predetermined time period is detected in step S32, the flow moves to step S34 to report the illegal parking to the police through the charging management company 4 and moves to step S36. On the other hand, when it is confirmed in step S22 or step S30 that another person's electric vehicle has exited and is not parked anymore, the flow moves directly to step S36. By the way, if parking is not detected in step S6, the flow moves directly to step S36. In step S36, charging management company 4 is notified that parking space 60 is available, and the flow returns to step S2. Steps S2 through S36 are repeated to deal with various changes. Since the information of the availability of parking space 60 is shared and with the charging management company 4 to open the information as described above, electric vehicles subscribing to the electric power lending/borrowing system on the road can know the availability of the nearest available charging household and its parking space upon necessity of charging.

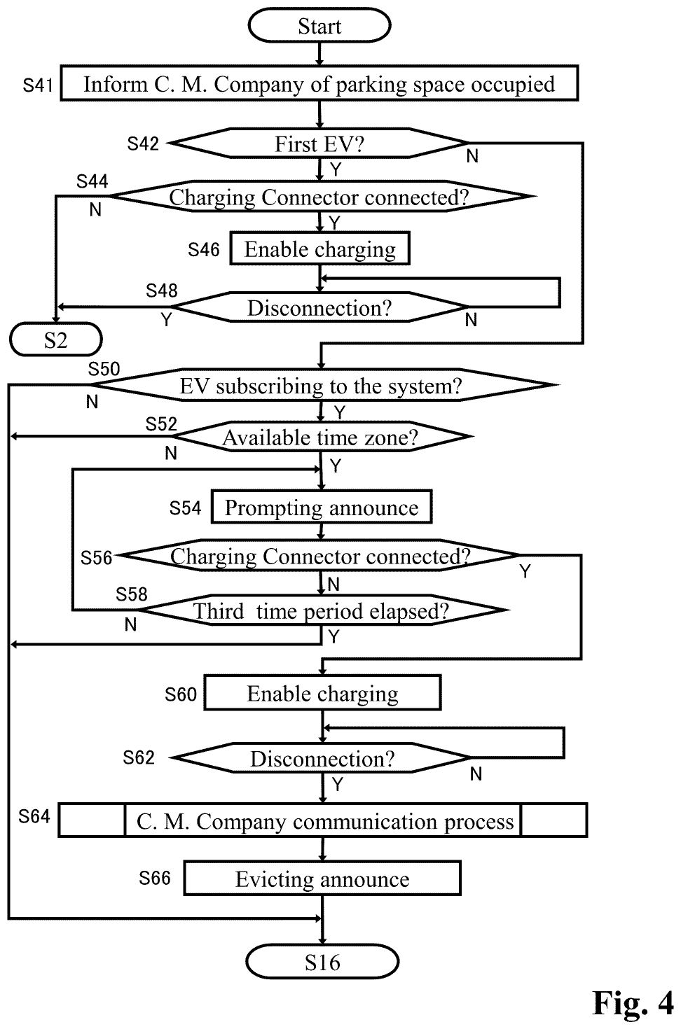

FIG. 4 is a flowchart showing the details of the charge control process in step S14 of FIG. 3. When the flow starts, it proceeds to step S41 to inform charging management company 4 of the fact that the vehicle is parked, and the flow moves to step S42. In step S42, a check is made to determine whether the vehicle identified in step S12 is first electric vehicle 22. If the parking of first electric vehicle 22 is determined, the flow proceeds to step S44 to check whether or not charging connector 58 is connected with EV connector 62. If there is no connection, it returns to the beginning of step S2 in FIG. 3. The lack of connection corresponds to the case where first electric vehicle 22 has returned to parking space 60 and there is no need to charge it, or it has not yet entered the charging. In this case, the flow goes from step S2 through step S12 to step S14 which comes to step 44. Since the flow repeats from step S44 back to step S2, the connection to charging connector 58 can be detected at step S44 at any time.

If the connection to charging connector 58 is detected in step S44, the flow goes to step S46 to enable charging from the charging connector 58 to EV connector 62 and start charging. The flow then proceeds to step S48 to check whether or not the connection to charging connector 58 has been released. This check is repeated at step S38 until the connection is released. When charging is completed and it is detected in step S48 that the connection has been released, the flow returns to step S2. The above is the case where it is first electric vehicle 22 that parks in parking space 60, and no further steps are taken after step S16 in FIG. 3, and no electric rate liquidation takes place.

In contrast, if it is detected in step S42 that the vehicle identified in step S12 was not first electric vehicle 22, the flow goes to step S50 to check whether or not the identified vehicle is a member of the electric power lending/borrowing system. This check is performed by inquiring with the charging management company 4 about the identified vehicle. If it is not determined in step S50 that the vehicle is a member of the electric power lending/borrowing system, the flow goes to step S16 in FIG. 3 for the purpose of evicting this vehicle unless it is an emergency.

On the other hand, if it is confirmed in step S50 that the identified vehicle is a member of the electric power lending/borrowing system, it goes to step S52 to check the relationship between the electric power available time zone set in step S2 and the current time. If it is determined in step S52 that the current time is not in the available time zone, the process goes to step S16 in FIG. 3 for the purpose of evicting this vehicle unless it is an emergency situation.

In contrast to the above, if it is confirmed in step S52 that the current time is in the available time zone, the system goes to step S54 and makes an announcement prompting the vehicle to start charging. This announcement is accompanied with a warning notice that the parking prohibition process will be initiated if charging is not started within a predetermined time. Next, the flow proceeds to step S56 to check whether or not charging connector 58 is connected with EV connector 62. If there is no connection, the system goes to step S58 to check whether or not the third predetermined time has elapsed. This third predetermined time is set, for example, to 10 minutes after parking is detected in step S6 in FIG. 3. If the elapse of the third predetermined time period is not detected in step S58, the flow returns to step S54 and repeats steps S54 to S58 until the elapse of the third predetermined time period is detected. On the other hand, when the elapse of the third predetermined time is detected in step S58, the flow goes step S16 in FIG. 3 and enter the process to evict this vehicle unless it is an emergency situation.

On the other hand, if the connection to charging connector 58 is detected in step S56, the flow goes to step S60 to enable it to start charging from the charging connector 58. Then, the flow proceeds to step S62 to check whether or not the connection to the charging connector 58 has been released. This check is repeated in step S60 until the connection is released. When the disconnection is detected in step S62, the flow enters the charging management company communication process in step S64. The disconnection is caused by the completion of the charging, for example. In step S64, charging management company 4 is informed of the identification information of the vehicle subscribing to the electric power lending/borrowing system and the amount of power that has been borrowed this time. The flow then proceeds to step S66 to make an announcement that the vehicle has to leave parking space 60. The flow then proceeds to step S16 in FIG. 3 to enter into the process for evicting the vehicle from parking space 60 unless there is an emergency.

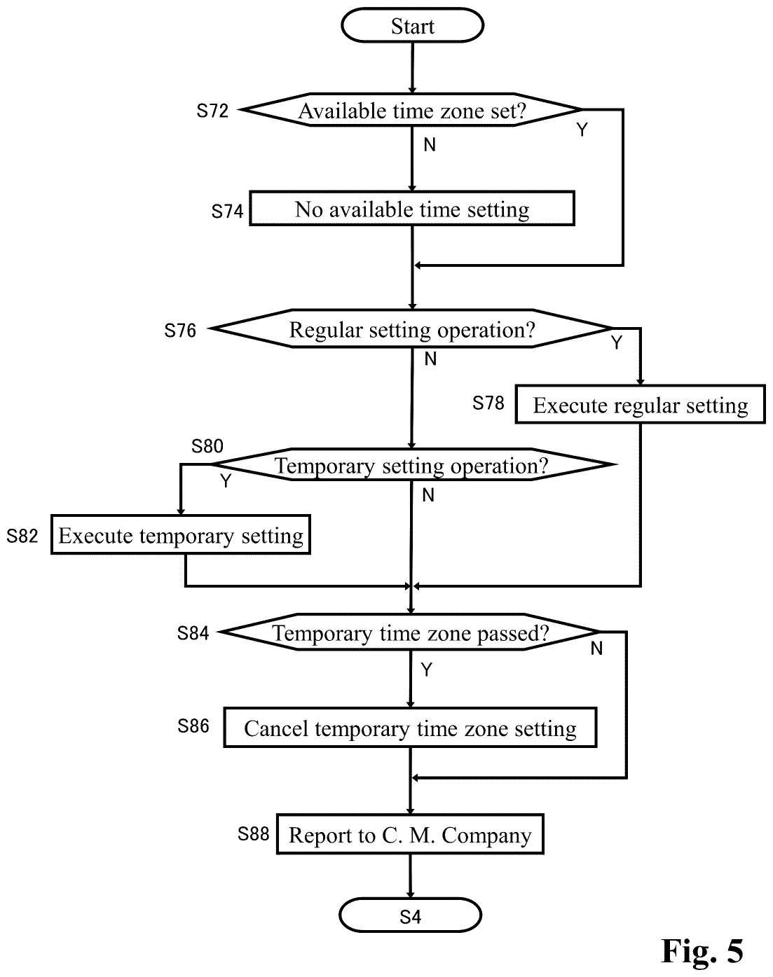

FIG. 5 is a flowchart showing the details of the available time zone setting process in step S2 of FIG. 3. When the flow starts, it is checked in step S72 whether or not the available time zone has already been set. If not, the flow proceeds to step S74 to perform the initial automatic setting of no available time zone, and then moves to step S76. If it is checked in step S72 that the available time zone has already been set, it moves directly to step S76.

In step S76, it is checked whether or not a regular available time zone setting operation is performed for setting available time zone, which is to be repeated regularly or periodically, e.g., “10:00-18:00 every day” or “every Sunday”. If there is any operation in step 76, the flow moves to step S78 to execute the regular available time zone setting. In such a setting is made once in step S78, the regular available time zone setting is to be repeated without setting again unless the setting will be deleted. On the other hand, if no operation is detected in step S76, the flow moves to step S80 to check whether or not an operation to set a temporary available time zone is performed. If there is an operation detected in step S80, the operation moves to step S82 to execute the temporary available time zone setting. This temporary available time zone setting is limited to the set day of the week and time zone. On the other hand, if no operation is detected in step S80, the flow moves to step S84. Also, when the setting is executed in step S78 or step S82, the flow moves to step S84.

In step S84, it is checked whether or not the temporary available time zone has passed. If it is determined in step 84 that the current time is out of the temporary available time zone which has passed, the flow proceeds to step S86 to automatically cancel the temporary available time zone and moves to step S88. On the other hand, if no elapse of the temporary available time zone is detected in step S84, the flow moves directly to step S88. In step S88, the latest status of the available time zone setting as described above is reported to charging management company 4, and the flow moves to step S4.

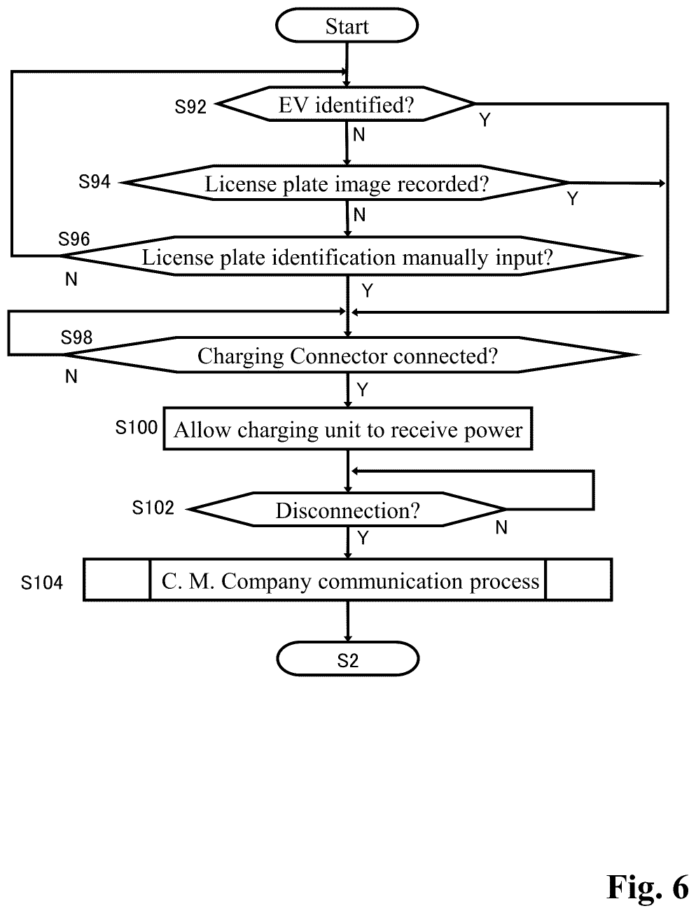

FIG. 6 is a flowchart showing the details of the emergency power receiving process in step S18 of FIG. 3. When the flow starts, it is checked at step S92 whether or not the vehicle has been identified. If it is determined in step S92 that the electric vehicle cannot be identified by any of ETC-ID sensor 80 and license plate OCR 82, the flow goes to step S94, in which an image of license plate of the electric vehicle is tried to be taken by camera 87 and the success of recording such an image is confirmed. If it is not confirmed in step 96 that the record of image of the license plate is recorded, the flow goes to step S96 to check whether the vehicle identification on the license plate has been manually inputted or not. When it is not confirmed in step S96 that the vehicle identification has been manually input, the system returns to step S92 and repeats steps S92 to S96 until the vehicle identification on the license plate has been manually inputted. The repetition of steps S92 to S96 can respond to any change in situations at S92 to S96 which leads to step S98 in the flow.

When it is confirmed in step S96 that the vehicle identification on the license plate has been manually entered, the flow moves to step S98. When vehicle identification is confirmed in step S92 or when it is confirmed in step S94 that there is an image record of the license plate, the flow moves directly to step S98.

In step S98, connection to charging connector 58 is checked. The check in step S98 is repeated until the connection is detected. If the connection to charging connector 58 is detected in step S98, the flow proceeds to step S100 to allow receiving power from the electric vehicle via the charging connector 58. Then, the flow goes to step S102 to check whether the connection to charging connector has been released. This check in step S102 is repeated until the connection is released. When it is detected in step S102 that the connection is released due to the completion of power reception, the flow enters the charging management company communication process in step S104. In this process, charging management company 4 is informed of the vehicle identification on license plate of the electric vehicle gotten in any of steps S92 to S96 and the amount of electricity received through charging connector 58. The flow then returns to step S2. By contacting charging management company 4, the electric vehicle parking in parking space 60 and supplying power to first household 10 can receive public compensation for the supportive power presentation in the event of a disaster or other emergency.

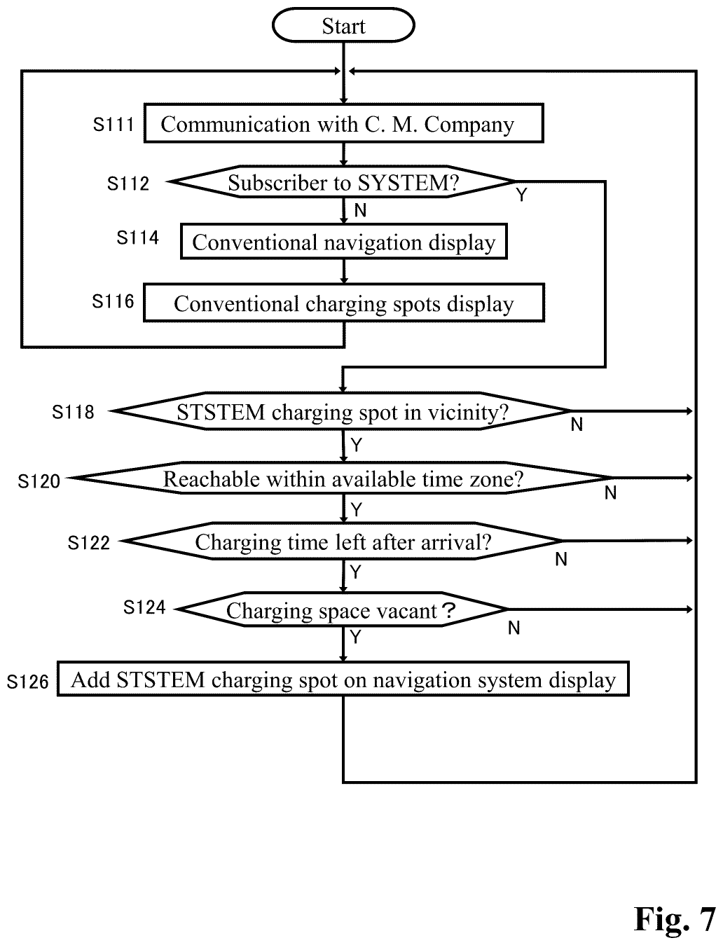

FIG. 7 is a flowchart showing the operation of the navigation control function of the EV controller 74 in first vehicle 22 shown in FIG. 2. This function is necessary when the first vehicle 22 is out of first household 10 and fills necessity of receiving electric power supply from another person's household. When the flow starts, in step S111, EV controller 74 is to communicate with charging management company 4 to obtain the latest information. Next, in step S112, it is checked whether or not first vehicle 22 is subscribed to the electric power lending/borrowing system. If first vehicle 22 fails to be recognized as the subscriber to the electric power lending/borrowing system, the flow proceeds to step S114 to present the conventional navigation display which does not include any indication of available households that are available for charging. In step S116, however, the flow has the conventional navigation system to present conventional map display of commercial charging spots, the flow then returning to step S111. Steps S111 to S116 are repeated as long as first vehicle 22 is not subscribed to the electric power lending/borrowing system.

On the other hand, if it is confirmed in step S112 that first vehicle A22 is currently subscribing to the electric power lending/borrowing system, the flow proceeds to step S118 to check whether or not there is any household subscribing to the electric power lending/borrowing system and in available time zone in the vicinity of the current location of first vehicle 22. If it is determined in step S118 that such a household available as a charging spot with a parking space according to the electric power lending/borrowing system exists in vicinity of first electric vehicle, the flow proceeds to step S120 to check whether or not the household as the charging spot is within a distance that can be reached by first vehicle 22 within the available time zone. If the check in step S120 is affirmative, the flow goes to step S122 to check whether or not it is an household as the charging spot with a sufficient available time zone left for first vehicle 22 to charge after its arrival. If this is also affirmative, the flow goes to step S124 to check whether or not the parking space of the household is vacant. If the parking space is vacant, the flow goes to step S126 to present the location of household as charging spot according to the electric power lending/borrowing system on the map display of the navigation system in addition to the location of the commercial charging spot, and returns to step S111. By repeating steps S111 through S126 in this manner, it is possible to respond to the need for charging while the electric vehicle is moving. Note that step S112 is included in the above repetition loop, so that when first vehicle 22 exits the electric power lending/borrowing system, the display of the household as charging spot according to the electric power lending/borrowing system will disappear from the map display of the navigation system with the location of the commercial charging spot.

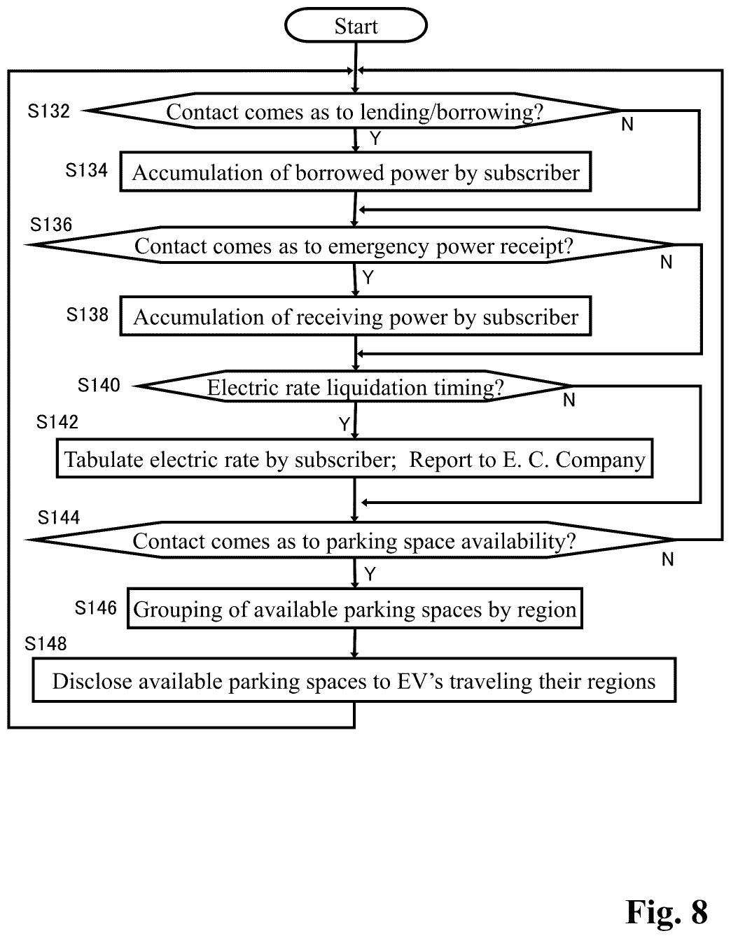

FIG. 8 is a flowchart showing the operation of management controller 32 of charging management company 4 in FIG. 1. If the flow starts, it is checked in step S132 whether or not a contact from a households subscribing to the electric power lending/borrowing system comes relating to respective borrowing of electric power by the electric vehicle from the household. If it is detected in step S132 that the contact comes, the flow proceeds to step S134, in which identifications of the household having the parking space as the lender and the electric vehicle owner as the borrower, respectively, and the amount of power borrowed by the vehicle owner from the household having the parking space are accumulated and stored in management controller 4 by respective subscriber, then the flow going to step S136. On the other hand, if no new contact is detected in step S132, the flow goes to step S136 directly.

In step S136, if it is checked whether or not management controller 4 is contacted by a household subscribing to the electric power lending/borrowing system which informs of receipt of electric power from other's electric vehicle upon emergency. If it is detected in step S136 that management controller 4 is contacted as to the emergency power receipt, the flow proceeds to step S138, in which identifications of the household receiving the emergency electric power and the electric vehicle owner providing the emergency electric power, respectively, and the amount of the emergency electric power are accumulated and stored in management controller 4 by respective owner of the electric vehicle, then the flow going to step S140. The owner of the electric vehicle is not only a subscriber of the power lending/borrowing system, but also is an ordinary owner outside the power lending/borrowing system. On the other hand, if no contact relating to the emergency electric power is detected in step S138, the flow goes to step S140 directly.

It is checked in step S140 whether or not a predetermined timing for the electric rate liquidation at power company comes. This timing is once a month, for example. If it is determined in step S140 that the timing comes, the flow proceeds to step S142 to tabulate lent/borrowed electric rate by respective subscriber, and to inform electric power company 2 of final result of subtracted lent/borrowed electric rate for respective subscriber. The flow then moves to step S144. If it is not determined in step 140 that the predetermined timing comes, the flow goes to step S144 directly.

In step S144, it is checked whether or not management controller 4 has contacted with the latest status report from the households subscribing to the power supply system for availability of their parking spaces. If it is detected in step S144 that management controller 4 is contacted as to the parking space availability, the flow proceeds to step S146, where management controller 4 groups the available parking spaces by region for travel, and then going to step S146. In step S148, management controller 4 discloses the latest information on the available parking spaces to all electric vehicles subscribing to the power lending/borrowing system that are traveling in their current region, the flow then returns to step 132. The steps S132 through S148 are repeated, which allows electric vehicles subscribe to the electric power lending/borrowing system to know the nearest parking space of households that are available for charging when necessary.

Various features of the above explained embodiment are applicable to electric vehicle charging systems, charging devices, electric power lending/borrowing systems, electric rate liquidation systems, and electric vehicles, etc., and can promote the installation of easy charging systems by streamlining the electric rate liquidation, etc.

The followings are summary of the various features of the above explained embodiment supporting the present invention.

For improving electric vehicle charging systems, charging devices, electric power lending/borrowing systems, electric rate liquidation systems, and electric vehicles, the present invention proposes an electric vehicle charging system comprising a building having a power consumption unit, a parking space attached to the building, a charging device for charging electric vehicles in the parking space, a power supply unit supplying power to the building and the charging device, and an electric rate liquidation system. When an electric vehicle is parked in the parking space and receives electric power from the charging device, the power supply unit is billed for the electric rate calculated so that the electric power for charging the electric vehicle is subtracted from the total electric power to the power supply unit, while an owner of the electric vehicle is billed for the electric rate corresponding to the electric power for charging the electric vehicle by means of the electric power lending/borrowing system.

The electric vehicle charging system is characterized in that it is equipped with an electric vehicle charging system that clears to charge the administrator of the electric vehicle. This means that even if an electric vehicle on the electricity demand side is charged by parking it in a parking space attached to a building, the electric vehicle can receive the same charge as if it were charged at home, and the building on the electricity supply side is practically not charged for that even if another person's electric vehicle charges the vehicle. Therefore, electric vehicles that have subscribed to the electric power lending/borrowing system can be charged in the parking spaces of other households that have subscribed to the electric power lending/borrowing system, even when they are out of the house.

According to specific features of the present invention, the building is a private residence and the parking space is a parking space for the private electric vehicle of the individual, and the power consumption unit is an electric facility at the private residence, and the optional electric vehicle is an electric vehicle of someone else for the individual. According to another specific feature, the building is a business facility for general consumers and the parking space is a parking space for electric vehicles of customers of the business facility, and the power consumption part is an electric facility in the business facility and the optional electric vehicle is an electric vehicle for the customer. Thus, according to the present invention, the charging equipment for private electric vehicles at private residences can be used as charging infrastructure for any electric vehicle without the hassle of settling power charges. In addition, the present invention can utilize not only private residences but also parking lots for business facilities for general consumers as charging infrastructure for any customer's electric vehicle without the hassle of settling power charges.

According to other specific features of the present invention, the electric power charge control process system includes a power supply system and a charging management system, wherein the charging management system identifies any electric vehicle and receives a report of charging power and reports it to the power supply system, and wherein the power supply system reports to the power supply system, and wherein the power supply system reports to the power supply unit the power supply system subtracts the power charge for the charging power to the electric vehicle identified above for the power charge, while the power supply system adds the power charge for the charging power to the electric vehicle identified above for the power supply unit of the manager of the electric vehicle identified above for the power charge to the electric vehicle identified above. According to another specific feature, the power charge control process system includes a charging management system, wherein the charging management system identifies any electric vehicle and receives a report of charging power and charges the administrator of the building, which is the power supply side, for the power charge for the charging power to the identified electric vehicle and the power The power charge for the electric power supply is settled between the administrator of the building, who is the power supply side, and the administrator of the electric vehicle, who is the demand side, with respect to the power charge for the electric power charged to the identified electric vehicle.

According to other specific features of the present invention, the charging device acquires information about any electric vehicle based on the license plate image or radio waves from the ETC on-board unit and reports it to the charging management system. This allows, for example, any electric vehicle to be identified for electric charge reimbursement. According to a more specific feature, the charging device records the acquired information of the electric vehicle. This allows, for example, the identity of any electric vehicle that is parked in a parking space of a private residence for charging to be identified and used as a charging infrastructure for any electric vehicle without the hassle of settling electricity charges and with security measures in place.

According to other specific features of the present invention, both the manager of the building, which is the power supply side, and the manager of any electric vehicle, which is the power demand side, are members of the electric power lending/borrowing system. This enables, for example, smooth electricity charge control process. According to a more specific feature of the present invention, the charging device prohibits charging of any electric vehicle when it cannot be confirmed that the administrator of the arbitrary electric vehicle parked in the parking space is a member of the electric power lending/borrowing system. This avoids problems such as power theft despite the fact that any electric vehicle is targeted. According to a more specific feature of the present invention, the charging device takes measures to have the manager of the arbitrary electric vehicle parked in the parking space remove it from the parking space when the manager of the arbitrary electric vehicle cannot confirm that it is a member of the electric power lending/borrowing system. This prevents illegal parking under the guise of power supply. According to another specific feature of the present invention, the electric power lending/borrowing system notifies the police when the administrator of any electric vehicle parked in the parking space cannot be confirmed as a member of the electric power lending/borrowing system based on the information of the charging device. This also prevents illegal parking under the guise of power supply.

According to other specific features of the present invention, the charging system takes measures to cause any electric vehicle to leave the parking space when it has been parked there for more than a predetermined time without charging. This prevents the vehicle from remaining in the parking space for an extended period of time under the pretext of charging, thereby depriving other vehicles of the opportunity to charge.

According to other specific features of the present invention, the charging device sets the time period during which charging is allowed for any electric vehicle and notifies the electric power lending/borrowing system, and the electric power lending/borrowing system publishes the location information of the parking space where charging is available to the car navigation system of any electric vehicle. This allows vehicles in urgent need of charging to know the nearest chargeable spots. According to a more specific feature of the present invention, the power charge control process system alerts the police based on the information of the charging device when the any electric vehicle is parked in the parking space outside of the time allowed for charging. This solves the situation where the building manager's own parking space is occupied by someone else's vehicle despite the building manager's own need for it.

According to other specific features of the present invention, the charging device can receive power supply from the storage battery of the own vehicle to the power consumption unit of the building when the own electric vehicle under the control of the building manager is parked in the parking space, and cannot in principle receive power supply from the storage battery of the own vehicle to the power consumption unit of the building when any electric vehicle is parked in the parking space. In principle, when any electric vehicle is parked in the parking space, it is not possible to receive power from the storage battery of any vehicle to the power consumption unit of the building. This prevents confusion in power charge control process due to receiving power feed from the storage battery of any electric vehicle when the storage battery of the vehicle is utilized as an auxiliary power source for the building. According to a more specific feature of the present invention, the charging device can receive a power supply to the power consumption section of the building from the storage battery of any electric vehicle parked in the parking space only in the event of a disaster or other emergency. This allows the building administrator to receive power supply assistance in an emergency such as a power outage due to a disaster, prioritizing the avoidance of disruption in power distribution. According to a more specific feature of the present invention, the power supply system allows the manager of any electric vehicle that parked in the parking space and supplied power to the power consumption unit of the building to receive public compensation for the power charge required for supplying power in the event of an emergency such as a disaster. This allows any vehicle to provide assistance without hesitation in the event of a disaster or other emergency, and to receive compensation after the assistance is rendered.

According to other specific features of the present invention, the system has a private power generation system capable of supplying power for consumption in the power consumption section and for charging the electric vehicle by the charging device, even when the power supply system supplies power from the private power generation system for charging the electric vehicle by the charging device, The system is liquidated so that the power charge to the power supply unit is charged minus the power charge required to charge any electric vehicle, while the system is liquidated so that the power charge required to charge any electric vehicle is charged to the administrator of any electric vehicle. This enables power clearing so that the power provided by the in-house power generation system out of the amount of power supplied to any electric vehicle is consequently sold by the building administrator to the electric power company.

According to other features of the present invention, a charging apparatus connected to a commercial power source for supplying power to any electric vehicle in a parking space where any electric vehicle can be parked, and comprising: an information acquiring unit for acquiring information on the optional electric vehicle; a measuring unit for measuring charging power to the optional electric vehicle; and a communication unit for reporting the power charge of the commercial power source and the power charge for charging the optional electric vehicle to an electric power charge control process system for settling the power charge for charging the optional electric vehicle. The electric vehicle charging apparatus is provided with a communication unit that reports the information on the optional electric vehicle acquired by the information acquisition unit and the charging power to the optional electric vehicle measured by the measurement unit to an electric power lending/borrowing system that settles the electric power charge required for charging the optional electric vehicle. This makes it possible, even if any electric vehicle is parked in a parking space and charged from a commercial power source, to identify the relevant vehicle and to correctly settle the power charge required for its charging by the electric rate liquidation system.

According to a specific feature of the present invention, the electric power charge control process system includes a charging management system, wherein the charging management system identifies any electric vehicle based on information on the electric vehicle from the communication unit and receives a report of the charging power and reports it to the administrator of the commercial power supply, and wherein the administrator of the commercial power supply is charged for the commercial power supply is charged by subtracting the power charge for the charging power to the identified electric vehicle, while the manager of the commercial power supply is charged by adding the power charge for the charging power to the identified electric vehicle to the power supply unit of the manager of the identified electric vehicle. According to another specific feature of the present invention, the electric power charge control process system includes a charging management system, wherein the charging management system identifies any electric vehicle based on the information of the electric vehicle from the communicator and receives a report of the charging power and charges the electric power charge for the charging power to the identified electric vehicle The system settles the power charges related to the power charge control process between the administrator of the charging equipment, who is the power supply side, and the administrator of the electric vehicle identified above, who is the power demand side, with respect to the power supply side and the demand side. In all of the above, the settlement of the power charge billing between the charging device side and the vehicle side that performed the charging is performed correctly.

According to other specific features of the present invention, the information acquisition section acquires information on any electric vehicle based on the license plate image or radio waves from the ETC on-board unit and reports it to the charge management system. This allows, for example, any electric vehicle to be identified for electric charge settlement. According to a more specific feature, the charging device records the acquired information of the electric vehicle. This allows, for example, the identity of any electric vehicle that is parked in a parking space of a private residence for charging to be identified and used as a charging infrastructure for any electric vehicle without the hassle of settling electricity charges and with security measures in place.

According to other specific features of the present invention, both the administrator of the charging device, which is the power supply side, and the administrator of any electric vehicle, which is the power demand side, are subscribers to the power charge control process system. Thus, an electric vehicle that is subscribed to the electric power lending/borrowing system can be charged at a parking space of a charging device that is subscribed to the electric power lending/borrowing system, even when the electric vehicle is out of the house. According to a more specific feature of the present invention, when the administrator of any electric vehicle parked in the parking space cannot confirm that the electric vehicle is a member of the electric power lending/borrowing system, charging of the electric vehicle is prohibited. This avoids problems such as power theft despite the fact that any electric vehicle is targeted. According to a more specific feature of the present invention, when the administrator of the arbitrary electric vehicle parked in the parking space cannot be confirmed that the electric vehicle is a member of the electric power lending/borrowing system, means are provided to evict it from the parking space. This prevents illegal parking under the guise of power supply.

According to other specific features of the present invention, the means is provided to cause any electric vehicle to leave the parking space when it has been parked in the space for a predetermined period of time or longer without charging. This prevents the vehicle from remaining in the parking space for an extended period of time under the pretext of charging, thereby depriving other vehicles of the opportunity to charge.

According to other specific features of the present invention, the charging device sets the time period during which charging is allowed for any electric vehicle and notifies the electric power lending/borrowing system, and the electric power lending/borrowing system publishes the location information of the parking space where charging is available to the car navigation system of any electric vehicle. This allows vehicles in urgent need of charging to know the nearest chargeable spots.

According to other specific features of the present invention, when one's own electric vehicle is parked in the parking space, one can receive power supply to the charging device by discharging the storage battery of one's own vehicle, and when any electric vehicle is parked in the parking space, in principle, one can receive power supply to the charging device by discharging the storage battery of any vehicle. When any electric vehicle is parked in the parking space, it is not possible, in principle, to receive power supply to the charging device by discharging the storage battery of the arbitrary vehicle. This prevents billing or other confusion caused by receiving power supply from the storage battery of any electric vehicle when the storage battery of the vehicle is utilized as an auxiliary power source for the charging device. According to a more specific feature of the present invention, the charging device can receive a power supply to the charging device from the discharge of the storage battery of any electric vehicle parked in the parking space only in the event of a disaster or other emergency. This allows the chargeing equipment to receive power supply assistance in emergency situations such as power outages due to disasters, prioritizing the avoidance of billing and other disruptions. According to a more specific feature of the present invention, the electric power charge control process system allows the manager of any electric vehicle that parked in the parking space and supplied power to the power consumption section of the building to receive public compensation for the power charge required to supply power in the event of a disaster or other emergency. This allows any vehicle to provide assistance without hesitation in the event of a disaster or other emergency, and to receive compensation after the assistance is rendered.

According to other specific features of the invention, the charging equipment can be fed from a private power generation system, and the electric power lending/borrowing system can be used to charge any electric vehicle by the charging equipment based on the power supply of the private power generation system, even if the power supply is fed for charging of the electric vehicle by the charging equipment, the power charge of the commercial power source and any electric vehicle The system settles the power charge for charging any electric vehicle. This allows for the clearing of the power feed from the private power generation system in the charging of any vehicle.

According to another feature of the present invention, when any electric vehicle receives a charge from a charging device installed in a parking space attached to a building, the information on the optional electric vehicle and the charging power is reported from the charging device, and the power charge for charging the optional electric vehicle to the administrator of the building is deducted from the power charge to the optional electric vehicle. On the other hand, the electric vehicles' power charge control process system is provided so that the electric vehicles' power charges to the administrator of any electric vehicle are charged to the administrator of any electric vehicle, while the electric vehicles' power charges to the administrator of any electric vehicle are charged to the administrator of any electric vehicle, minus the electric vehicles' power charges. This means that even if an electric vehicle on the electricity demand side is parked in a parking space attached to a building and receives a charge, it will receive the same charge as if it were charged at home, and the building on the electricity supply side will not be charged for the charge even if another person's electric vehicle charges the vehicle, in effect. Therefore, electric vehicles subscribing to the electric rate liquidation system can be charged in the parking spaces of other households subscribing to the electric power lending/borrowing system, even when they are out of the house.

According to another specific feature of the present invention, the electric power lending/borrowing system includes a power supply system and a charging management system, wherein the charging management system identifies any electric vehicle based on information from the charging device and reports it to the power supply system together with the charging power, and wherein the power supply The power supply system subtracts the power charge for the charging power to the identified electric vehicle from the power charge to the administrator of the building, and adds the power charge for the charging power to the identified electric vehicle to the power supply unit of the administrator of the identified electric vehicle to charge for the power charge to the identified electric vehicle. Charging. According to another specific feature, the electric power charge control process system includes a charging management system, wherein the charging management system identifies any electric vehicle based on information from the charging device and charges the electric power supplier of the building for the electric power for the charging power to the identified electric vehicle based on the charging power reported. The system settles the electricity charges related to electricity flexibility between the administrator of the building, who is the electricity supplier, and the administrator of the electric vehicle identified above, who is the electricity demander.

According to other specific features of the present invention, both the administrator of the building, which is the power supply side, and the administrator of any electric vehicle, which is the power demand side, are subscribed to the power charge control process system. This enables, for example, smooth power charge control process. According to a more specific feature of the present invention, the charging device is notified that the administrator of the arbitrary electric vehicle parked in the parking space cannot be confirmed to be a member of the electric power lending/borrowing system, thereby prohibiting the charging of the arbitrary parked electric vehicle by the charging device. This avoids problems such as power theft despite the fact that any electric vehicle is targeted. According to a more specific feature of the present invention, it notifies the charging device that the administrator of the arbitrary electric vehicle parked in the parking space cannot confirm that the arbitrary electric vehicle is a member of the electric power lending/borrowing system, and causes the charging device to take measures to cause the arbitrary electric vehicle to leave the parking space. This prevents illegal parking under the guise of power feeding. According to another specific feature of the present invention, the police are notified when the administrator of any electric vehicle parked in the parking space cannot be confirmed to be a member of the electric power lending/borrowing system based on information from the charging device. This also prevents illegal parking under the guise of power supply.

According to another specific feature of the present invention, the system receives information from the charging device about the time of day when charging is allowed for any electric vehicle and publishes the location information of the parking space where charging is available to the in-car navigation system of any electric vehicle. This allows vehicles in urgent need of charging to know the nearest chargeable spots. According to a more specific feature of the present invention, when the any electric vehicle is parked in the parking space outside of the time allowed for charging, a police report is made based on the information of the charging device. This solves the situation where one's parking space is occupied by another person's electric vehicle in time of need.

According to another specific feature of the present invention, the manager of any electric vehicle parked in the parking space and supplying power to the building in the event of a disaster or other emergency can receive public compensation for the power charges incurred in supplying power. This allows any vehicle to assist in supplying power to a building in a power outage without hesitation in the event of a disaster or other emergency, and to receive compensation after the assistance is rendered.

According to another specific feature of the present invention, the building has a private power generation system, while the building is liquidated so that even if the private power generation system is used to charge the optional electric vehicle, the power charge to the building is charged minus the power charge required to charge the optional electric vehicle, On the other hand, the electric power charge for charging any electric vehicle will be liquidated so that the administrator of the electric vehicle will be charged for the electric power charge required for charging any electric vehicle. This enables power clearing so that the power provided by the in-house power generation system out of the amount of power supplied to any electric vehicle is consequently sold by the building administrator to the electric power company.

According to other features of the present invention, a charging management system that enables charging to any electric vehicle by means of a charging device installed in a parking space attached to a private residence and that settles power charges between the manager of the private residence on the power supply side and the manager of any electric vehicle on the power demand side, and the charging The management system discloses the location information of the private residence where charging to any electric vehicle is possible to the car navigation system installed in the arbitrary electric vehicle. This allows vehicles in urgent need of charging to know the nearest chargeable spot. According to a specific feature of the present invention, the location information of the individual residence is published to the car navigation system on the condition that both the manager of the individual residence, which is the power supply side, and the manager of any electric vehicle, which is the power demand side, are subscribed to the electric power lending/borrowing system. This will ensure that parking of electric vehicles that are not subscribed to the electric power lending/borrowing system will not be invited. According to another specific feature of the present invention, the location information of the individual residence is disclosed to the car navigation system only during the time when charging is permitted at the individual residence. This allows the building manager to avoid inviting the parking of other people's vehicles despite the building manager's own needs.

According to other features of the present invention, the electric vehicle can be charged by a charging device installed in a parking space attached to a private residence, and is subscribed to a charging management system that settles power charges with the manager of the private residence on the power supply side, and is also subscribed to the charging management system to charge any electric vehicle The electric vehicle is provided with a car navigation system that discloses the location of the private residence. This allows the vehicle to know the nearest available charging spot when there is an urgent need for charging. According to a specific feature of the present invention, the vehicle has an ETC on-board unit that provides information about the electric vehicle to the private residence for settlement of the electric charge when the vehicle is parked in a parking space attached to the private residence. This facilitates the identification of the own vehicle necessary for the settlement of the charge fee.

According to another feature of the present invention, when any electric vehicle receives a charge from a charging device installed in a parking space attached to a building, based on the identification of the arbitrary electric vehicle and information on the charging power, the electric power charge for the charging power to the identified electric vehicle is subtracted from the electric power charge for the supply of electric power to the administrator of the building. On the other hand, the electric charge clearing system is characterized in that the electric charge for supplying electric power to the manager of the electric vehicle identified above is charged by adding the electric charge for charging the electric vehicle identified above to the electric charge for supplying electric power to the manager of the building identified above. This ensures correct settlement of the power charge billing between the charging device side and the vehicle side that performed the charging.

What is claimed is:

1. An electric vehicle charging system comprising:
a building having a power consumption unit;
a parking space attached to the building;
a charging apparatus for charging electric vehicles in the parking space;
an electric power supply unit supplying power to the building and the charging device; and
an electric power lending/borrowing system, wherein when any electric vehicle is parked in the parking space and charged by the charging device due to the power supply unit, the power lending/borrowing system controls electric rate liquidation so that the electric power supply unit is billed for the electric power supply unit minus the electric power charging the electric vehicle, and that the electric power charging the electric vehicle is billed to an owner of the electric vehicle.

2. A charging apparatus connected to a commercial power source for supplying power to any electric vehicle in a parking space where any electric vehicle can be parked, comprising:
an information acquiring unit for acquiring information for identifying the electric vehicle;
a measuring unit for measuring amount of power for charging the electric vehicle; and
a communication unit for informing a power lending/borrowing system of the information for identifying the electric vehicle and amount of power for charging the electric vehicle for the purpose of such an electric rate liquidation that the electric power supply unit is billed for the electric power supply unit minus the electric power charging the electric vehicle, and that the electric power charging the electric vehicle is billed to an owner of the electric vehicle, wherein the power lending/borrowing system reporting necessary information to the commercial power source for billing liquidated electric rate.

3. A power lending/borrowing system comprising:
a charging management system that enables to charge any electric vehicle by a charging device installed in a parking space attached to a private residence and to liquidates electric rate between the private residence and the owner of the electric vehicle; and
a communication unit for informing electric vehicles on their navigation systems, respectively, of the location of the private residences reachable by the electric vehicles, respectively.
